(19) United States
(12) Patent Application Publication
(10) Pub. No.: US 2007/0082550 A1
(43) Pub. Date: Apr. 12, 2007

(54) Shielded connector module housing with heatsink

(75) Inventors: Steven M. Hemmah, Goffstown, NH (US); David Arciniega, Sachse, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED

(21) Appl. No.: 11/247,699

(22) Filed: Oct. 11, 2005

(51) Int. Cl. H01R 13/648

(52) U.S. Cl. 439/607

(57) ABSTRACT

A port connector module supplies power over Ethernet with a power supply mounted to the port housings. The compact arrangement for providing distributed power frees up significant space in the system architecture, while providing a high degree of functionality for power management operations. The power board integrates a number of functions for power management, and can communicate with a host controller. The port housing and power board are enclosed by a shield to reduce EMI radiation or noise emissions. A heat sink is mounted to the shield to dissipate thermal energy from the power board. The solution provides greater compactness and integration to reduced cost and space for distributed power applications.

### CROSS REFERENCE TO RELATED APPLICATIONS

### STATEMENT REGARDING FEDERALLY SPONSORED RESEARCH OR DEVELOPMENT

### BACKGROUND OF THE INVENTION

1. Field of the Invention

The present invention relates generally to communications equipment and relates more specifically to a modular jack having a plurality of ports. The modular jack includes a shielded housing that contains a printed circuit board. The printed circuit board contains power and port management circuitry as well as interface circuitry for coupling the respective ports to a physical interface (PHY).

2. Description of Related Art It is common in communications equipment to interconnect devices via standard communication interfaces that operate with common protocols to form a network. A well known example of a communication network is based on an Ethernet protocol, based on IEEE 802.3 specifications, where information is exchanged between various senders and receivers connected to the network, often through a switch. The networks are typically formed with Ethernet equipment such as switches, bridges, routers and other communications devices, where one network device can communicate with another network device through the equipment. A number of network devices are usually connected to the equipment. To this end, modular jacks have been developed that include a plurality of ports for coupling devices to respective communication cables terminating in connectors such as the well-known RJ-45 connector.

Typically, such modular jacks are operated with electronics that are mounted separately on a printed circuit board external to the ports or the port module. For example, the physical interface, or PHY component of the port module, may be mounted on a system board external to the module, or may be mounted on a board adjacent to the ports in the module. Any additional functionality desired for the port module is thus typically realized through devices mounted to the external circuit board. Each port may contain some device components for operating each port, such as magnetic components, which are typically mounted within a port housing.

One application for network communications that calls for additional functionality at the port module is the provision of power over network connections. For example, a network connected device for transferring information over the network may receive power from the network so that alternate power sources for the devices are not necessary. A typical advantage associated with providing power over a network is that a user can physically connect a device to the network to transfer information, and the device can be powered without the need of batteries or running additional power lines to the physical location of the user. Power over Ethernet (POE) may be provided through power sourcing equipment (PSE) that distributes power to powered devices (PDs) in a network environment. The network environment for realization of a POE system typically supports IEEE 802.3af or 802.3at specifications.

POE equipment typically includes PSE controller ICs that deal with management of the supplied power over the Ethernet connection. The PSE ICs and associated circuitry are provided as a mix of digital and analog components and circuits that are used to control power supplied to the Ethernet connection, and supply feedback concerning power status to a host or other master control.

PSE devices typically provide a number of ports to permit multiple Ethernet connections in a module. Often because of the number of ports in a PSE device, component and board space is at a premium. The port connector modules in the PSE devices can include signaling input and output control, information input and output connections, LED drivers and LED devices, power supply controllers for supplying power to each port, as well as connections for bringing power to each port connector. Accordingly, the port connector module has extremely limited space for additional functionality that would be desired for the realization of a number of POE or other applications, for example. It would be desirable to free up as much space as feasible in the port connector module of the PSE device for additional functionality and applications. Alternatively, or in addition, it would be desirable to condense functionality in the module.

### BRIEF SUMMARY OF THE INVENTION

In accordance with the present invention an active local area connector is disclosed. The active local area connector includes a modular jack having a plurality of communication ports for receiving connectors, such as RJ-45 connectors. The presently disclosed connector includes a printed circuit board (PCB) in the modular jack. The printed circuit board is mounted within a shielded enclosure to avoid interference with the circuitry contained thereon.

A communications system includes first and second modular jacks at first and second respective ends coupled by a communication link including a plurality of twisted pair wires. More specifically, at the first end, a power source is coupled to a connector of the modular jack to supply a DC voltage to the modular jack. The DC voltage is DC coupled to the twisted pairs and recovered at the second and of the communication link. The DC voltage may be employed at the second end of the communication link to power electronic equipment, thereby avoiding the need for a separate power source at the second end of the link. In the foregoing manner, for example, power may be supplied over conventional CAT-5, CAT-5e or CAT-6 wiring while the same wiring is employed to carry Ethernet signaling.

In one embodiment, the printed circuit board that is mounted within the shielded enclosure of the modular jack includes the magnetic interface circuitry that allows Ethernet signaling and power to be coupled to the respective twisted pairs at the source end and that allows the Ethernet signaling and power to be recovered from the twisted pairs at the second end of the communications link.

In another embodiment, port management and control circuitry is also included on the printed circuit board that is mounted within the shielded enclosure of the modular jack. The power management and control circuitry may include power sourcing equipment control, power FET control, current sensing circuitry, current measurement circuitry, voltage measurement circuitry, temperature measurement circuitry, optocoupler circuitry, LED drivers and priority shutdown circuitry.

Other features, aspects and advantages of the presently disclosed modular jack will be apparent to those of ordinary skill in the art from the Detailed Description of the Invention taken in conjunction with the drawings that follow.

### BRIEF DESCRIPTION OF THE SEVERAL VIEWS OF THE DRAWINGS

The invention will be more fully understood by reference to the following Detailed Description of the Invention in conjunction with the drawings of which:

FIG. 1 is an exploded perspective view of a port module in accordance with the present invention;

FIG. 2 is a perspective view the assembled port module in accordance with the present invention.

### DETAILED DESCRIPTION OF THE INVENTION

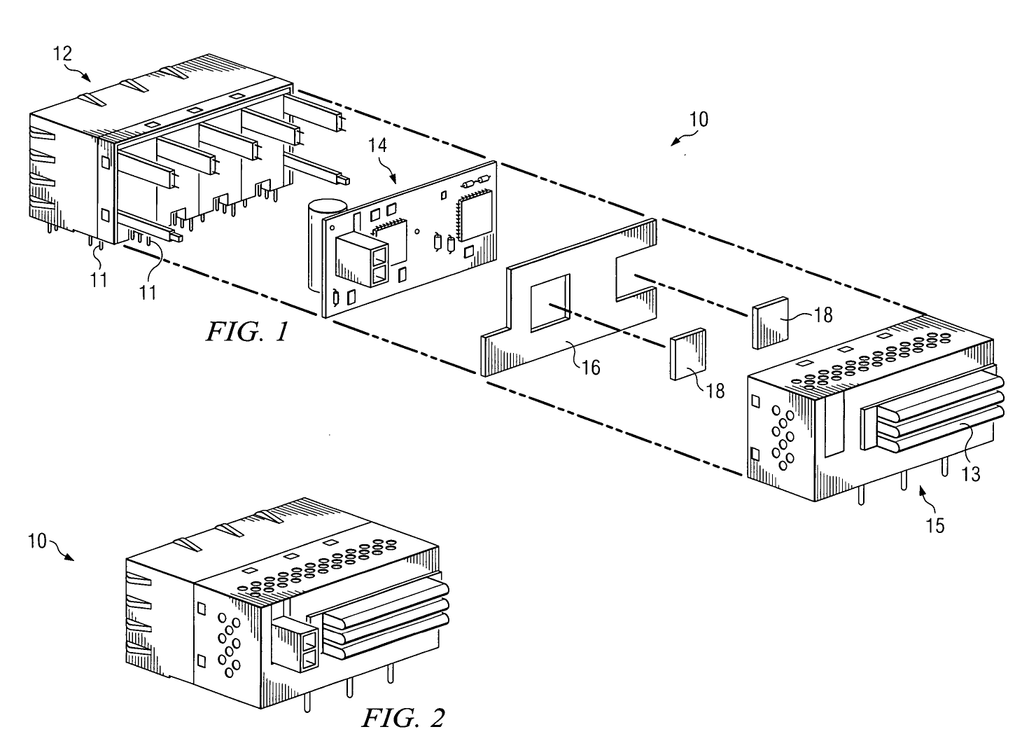

Referring now to FIG. 1, an illustration of the port or jack module according to an embodiment of the present invention is illustrated in an exploded perspective as module 10. Module 10 includes a port connector section 12, a power supply board 14, a gap filler or spacer 16 and power controller ICs 18. Port module 10 is also provided with a shield 15 that covers power board 14 and shields other components external to module 10 from EMI or other noise sources. FIG. 2 illustrates module 10 in an assembled state.

Port connector section 12 of port module 10 includes cable connection sites, typically provided as RJ-45 connectors. Each port connector in section 12 includes a housing in which various magnetic components are located to support signaling according to Ethernet specifications. In addition, each port has one or more associated LEDs visible from outside of the port to indicate status of a port, for example. Section 12 may also include a number of vertical or horizontal PCB components that support various standard functions for signaling in the ports. For example, the PCBs can provide the LED drivers and other signal conditioning circuitry for communication with other devices coupled to the port through a network connection.

In typical Ethernet applications, port housing section 12 is all that is needed to provide a multi-port connector for switching equipment, for example. However, a number of challenges arise if it is desired to supply power over Ethernet connections, due to the limited space, independent operation of each port, and desired power management functions that can help prevent equipment or component damage for devices in the power distribution network. In accordance with the present invention, power supply board 14 is provided to port housing section 12 to meet the challenges of supplying power over Ethernet connections.

Power board 14 provides a number of power sourcing functions for supplying POE, and can include local power controllers 18 that can supply power control and interfacing with a host controller. Previous solutions for providing POE with a port housing section 12 used a system board to which section 12 was coupled, typically, through soldering or press fit connections. For example, pins 11 illustrated on a bottom of section 12 were used to connect to port wires for providing POE to connectors plugged into the ports. The solution provided by power board 14 frees up space on a system board to which module 10 is connected, while providing a number of sophisticated power control functions to deliver POE.

One difficulty in realizing power board 14 as a complex solution directly mounted to port housing section 12 is the amount of heat dissipation produced by components on power board 14. Indeed, prior realizations of POE modules require the power board to be mounted outside of a case of a port module, to obtain the appropriate air flow to cool the power board sufficiently to maintain operating specifications within a desired range. The solution provided by power board 14 permits heat dissipation in a managed configuration, so that power board 14 can be covered by shield 15, with a heat sink 13 mounted to shield 15 to provide appropriate shielding and heat dissipation at the same time.

By providing the configuration of port module 10, a more integrated POE solution is provided that reduces cost of the application. The more integrated design therefore reduces overall system cost, and frees space on other circuit boards for desirable additional functionality. Some of the functions that can be provided by power board 14 include PSE control, power FET control, current sense resistors, current measuring, voltage measuring, temperature measuring, optocoupler circuitry, LED drivers and priority shutdown control. The LED drivers that are located on smaller boards within port housing section 12 can be relocated to power board 14 to free up additional space in port housing section 12. Power board 14 can also implement high level functions, such as priority shutdown control, where certain ports are given priority over others in the event of a main power supply failure or power supply switchover event. Power board 14 can be further integrated with Ethernet signaling components, such as the PHY interface that is responsible for the physical communication signals over network connectors. For example, a PHY controller can be located on power board 14 and can include functionality that is integrated into power board 14 to contribute to providing an overall power and signaling distribution network.

Port module 10 can be configured to support a number of Ethernet specifications, including 10 megabit, 100 megabit, 10/100 megabit and 1 gigabit communication speeds. Power board 14 can also support a number of interfaces with a host, such as an I²C bus, SPI interface, and the like. Port module 10 can be powered with one or more power supplies, and may have power connections supplied through a cable or through pins that may be connected with terminals, press fittings or soldered, for example. Because of the communication facilities provided by power control ICs 18, real time voltage and current values can be provided to a host controller to make high level decisions regarding power control. Power board 14 also has a number of available features, such as current ramp up and ramp down settings for EMI reduction and selectable overcurrent shutdown thresholds. Power board 14 can also provide a number of fault detection features, such as over/under voltage and current fault detection for each port in port module 10. Furthermore, power board 14 can take temperature measurements for each port and provide over-temperature protection in supplying power to each port. Also, power board 14 supports hot plugable devices, in that network connectors may be removed from the ports in port module 10 to disconnect power supplied over the network connector.

By integrating a high degree of functionality in power board 14, a number of other advantages can be achieved with respect to system board functionality. For example, integrating the functionality into power board 14 can eliminate shift registers, heat sinks, support PCBs and opto couplers from system boards to further free up space in system board architecture. Port module 10 can accommodate all of these functions, and more, and still reside within shield 13 to provide good EMI protection while maintaining an appropriate thermal operating range.

Although the present invention has been described in relation to particular embodiments thereof, other variations and modifications and other uses will become apparent to those skilled in the art from the description. It is intended therefore, that the present invention not be limited not by the specific disclosure herein, but to be given the full scope indicated by the appended claims.

What is claimed is:

1. A port module for supplying distributed power and communication signaling connectivity, comprising:
a port with a housing suitable for receiving a connector to distribute power and communication signals;
a power supply connected to the port for supplying power over the network connection, the power supply being mounted in close proximity to the housing;
a shield covering the power board on a plurality of sides, the shield being mounted to the housing.

2. The module according to claim 1, further comprising a heat sink in the shield and thermally coupled to the power board.

3. The module according to claim 1, further comprising a plurality of ports, each being connected to the power board.

4. The module according to claim 1, further comprising a communication interface on the power board for communicating with a host controller.

5. The module according to claim 1, further comprising mounting projections for use with mounting the module to a system board.

6. The module according to claim 5, wherein the projections are electrically conductive.

7. A method for providing distributed power over a communications network, comprising:
mounting a power supply to a multi-port connector device;
mounting a shield to cover the port device and the power board.

8. The method according to claim 7, further comprising dissipating thermal energy from the power board through a heat sink mounted to the shield.

9. A power over Ethernet power supply module, comprising:
an Ethernet connector housing for providing connectivity with Ethernet transmission lines;
a power board mounted to the housing and connected to each port to supply power to each port; and
a shield covering a majority of the power board and the housing.

10. The module according to claim 9 further comprising a heat sink coupled to the shield for dissipating thermal energy from the power supply.
